(19) United States
(12) Patent Application Publication
(10) Pub. No.: US 2008/0040514 A1
(43) Pub. Date: Feb. 14, 2008

(54) INFORMATION-PROCESSING APPARATUS AND INFORMATION-PROCESSING METHOD

(75) Inventor: Ryo Hatano, Kodaira-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 11/836,090

(22) Filed: Aug. 8, 2007

(30) Foreign Application Priority Data
Aug. 9, 2006 (JP) 2006-217067

(51) Int. Cl. G06F 3/00

(52) U.S. Cl. 710/1

(57) ABSTRACT

According to one embodiment, an information-processing apparatus comprises means for reproducing information from an optical disc loaded in a disc unit by using an application program, a persistent storage configured to store an additional content related to the optical disc loaded in the disc unit, a display device configured to display a list of contents including a name of the additional content stored in the persistent storage and a name of a provider of the additional content, and means for processing any additional content that is stored in the persistent storage and is selected by a user in the list of contents displayed by the display device.

### CROSS-REFERENCE TO RELATED APPLICATIONS

This application is based upon and claims the benefit of priority from Japanese Patent Application No. 2006-217067, filed Aug. 9, 2006, the entire contents of which are incorporated herein by reference.

### BACKGROUND

1. Field

One embodiment of the present invention relates to an information-processing apparatus and an information-processing method, which plays back the content recorded on optical discs.

2. Description of the Related Art

Optical discs, i.e., storage media that can store video content or audio content at high density have long been practically used.

Content can be played back from an optical disc at any position on the disk, unlike from tape-shaped media. Further, optical discs have a larger storage capacity per physical unit area than tape-shaped media. Therefore, optical discs are used in rapidly increasing numbers.

In recent years, high-definition digital versatile discs (hereinafter referred to as HD DVDs) have come into practical use. One HD DVD can store both video data conforming to the high-definition (HD) standard and high-quality surround audio data. The content (information) can be played back from the HD DVD by applying a laser beam of a short wavelength, i.e., a blue or bluish purple light beam.

An optical disc conforming to the HD DVD standard (including an optical disk conforming to a specific DVD standard) stores a particular type of content (called advanced content), which contains an address or link data that recommends access to the provider of this content through a network. When the provider is accessed, additional content related to the content recorded on the optical disc can be downloaded. The additional content is, for example, video data added after the video software has been prepared, original programs prepared exclusively for the purchasers of the video software, audio data in languages other than the language in which the audio data contained in the video software, and the like. Thus, when the optical disc is played back in a player, any content downloaded via the network can be reproduced, at the same time as, or in parallel with, the content recorded on the optical disc. The additional content includes, for example, a list of new arrivals, i.e., a list of new video software items the provider has just started providing.

The HD DVD standard defines a persistent storage that is a memory device for storing the additional content thus downloaded. A persistent storage has two categories. A required persistent storage refers to an in-player storage device and an additional persistent storage refers to optional additional storage devices. The required persistent storage is a medium, such as flash memory, provided in the player. The additional persistent storage is a removable medium, which can be, for example, a USB memory, a portable HDD, a memory card, or the like.

When the player plays back content such as game software items, it generates various data items such as game scores and high scores. The game scores and the like, thus generated, are not erased and can be effectively used as long as the optical disc remains loaded in the player. However, when the optical disc is removed from the player so that it may be replaced with another or when the power switch on the player is turned off, the information hitherto generated, such as game scores, is erased unless any specific measures are taken. In view of this, the information related to the content, such as high scores, is stored as additional content in the persistent storage.

HD DVDs may be played back, not only by dedicated player, but also by personal computers in which an application for playing back HD DVDs is installed. Such an application can indeed access the content on the optical disc, cause a display to display the content menu or the like and make the player reproduce the content. However, it cannot access the additional content in the persistent storage to display the content menu or perform a process such as the erasing of the additional content.

A digital TV receiver that can display stored information, not the information recorded on DVDs, is disclosed in Jpn. Pat. Appln. KOKAI Publication No. 2002-247471. This digital TV receiver can store a great amount of information, because it has a storage device having a large capacity and manufactured at low cost. While the viewers are enjoying a TV program displayed on the screen, stored information related the TV program may be displayed on a part of the screen, making it possible to give useful information to both the viewers and the information provider. Alternatively, the stored information may be displayed after the TV programs have been broadcast.

However, the application program that enables the conventional optical disk drive to playback optical discs cannot cause displays to display the content of persistent storage or perform the management of the content.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view showing the outer appearance of a personal computer according to an embodiment of the present invention;

FIG. 2 is a block diagram showing a system configuration that the personal computer of FIG. 1 may have;

FIG. 3 is a diagram explaining a method of managing a DVD file;

FIG. 4 is a diagram showing the directory configuration of a DVD file and explaining a method of managing the files in the personal computer shown in FIG. 1; and

FIG. 5 is a diagram showing an example of a persistent storage management menu.

### DETAILED DESCRIPTION

Various embodiments according to the invention will be described hereinafter with reference to the accompanying drawings. In general, according to one embodiment of the invention, an information-processing apparatus comprises means for reproducing information from an optical disc loaded in a disc unit by using an application program, a persistent storage configured to store an additional content related to the optical disc loaded in the disc unit, a display device configured to display a list of contents including a name of the additional content stored in the persistent storage and a name of a provider of the additional content, and means for processing any additional content that is stored in the persistent storage and is selected by a user in the list of contents displayed by the display device.

Hereinafter, embodiments of an information-processing apparatus and an information-processing method, both according to the present invention, will be described with reference to the accompanying drawings.

### First Embodiment

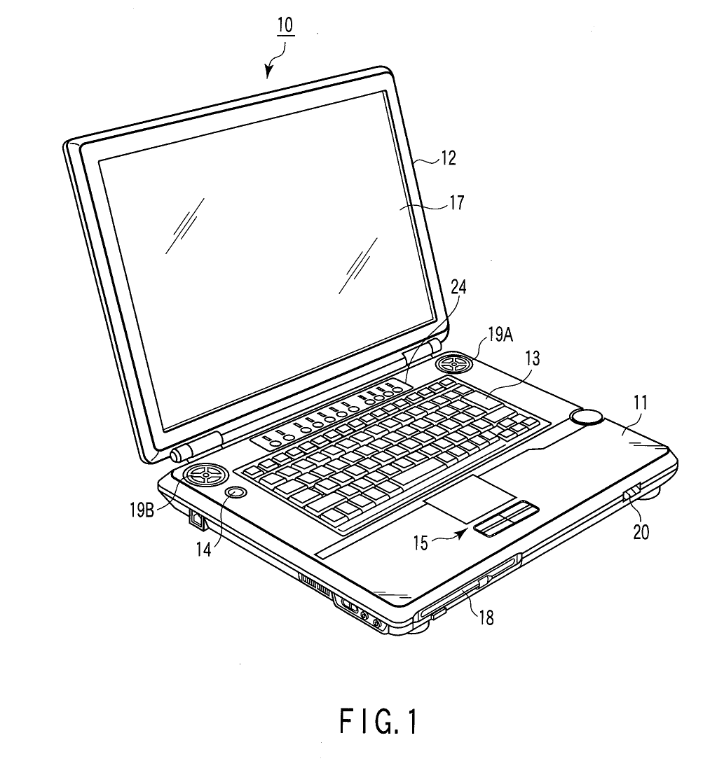

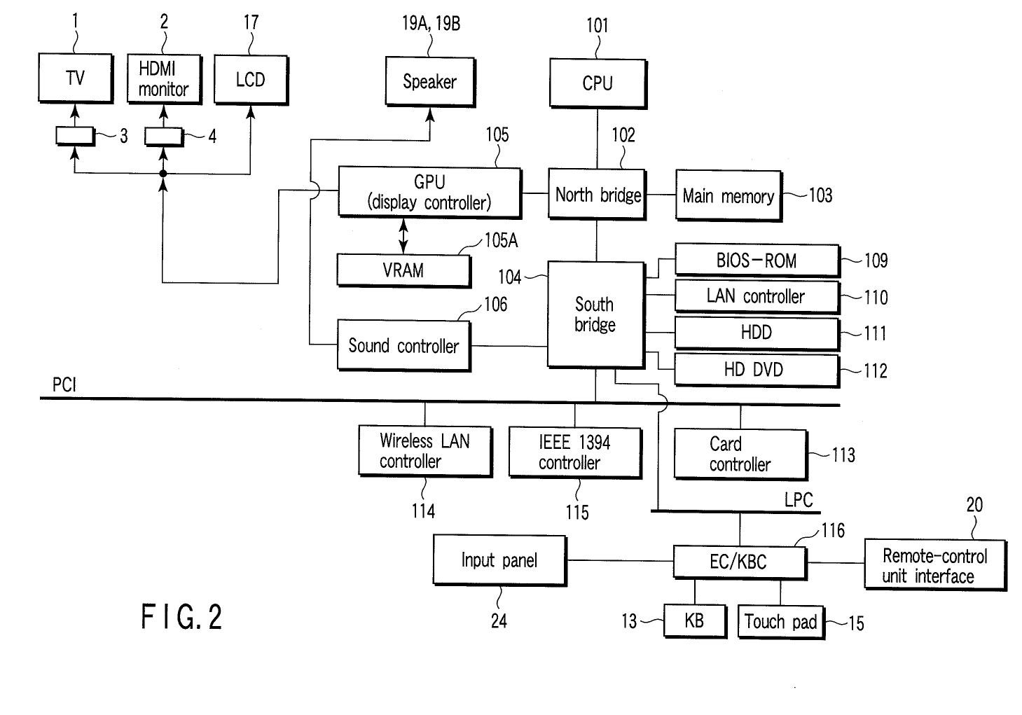

First, an information-processing apparatus according to an embodiment of this invention will be described, with reference to FIGS. 1 and 2. The information-processing apparatus is realized in the form of, for example, a notebook-type personal computer 10.

FIG. 1 is a perspective view of the notebook-type personal computer 10 with the display unit opened. The computer 10 comprises a main unit 11 and a display unit 12. The display unit 12 incorporates a display, which is a thin-film transistor liquid crystal display (TFT-LCD) 17. The LCD 17 has a display screen, which is located almost as the center part of the display unit 12.

The display unit 12 is hinged to the main unit 11 of the computer 10 and can be rotated between an opened opposition and a closed position. The main unit 11 is shaped like a thin box. A keyboard 13, a power button 14, a touchpad 15, speakers 19A and 19B, and the like are secured to the upper surface of the main unit 11. The power button 14 may be operated to turn the computer 10 on and off. The main unit 11 incorporates a DVD-ROM drive 18. The DVD-ROM drive 18 has an opening, which is made in the front of the main unit 11. Through the opening a DVD can be inserted into the DVD-ROM drive 18. A remote-control unit interface 20 is provided on the front of the main unit 11. The remote-control unit interface 20 is configured to perform communication with a remote control unit (not shown) that is used to control the playback function of the optical disk provided in the computer 10. The interface 20 comprises, for example, an infrared-ray signal receiving unit. The DVD-ROM drive 18 can play back not only HD DVDs, but also optical discs such as CDs and DVDs.

The touchpad 15 may be operated, instead of a mouse, in order to move the cursor on the display screen and select one of the items displayed on the display screen.

An input panel 24 is arranged on the rear part of the main unit 11 and close to the keyboard 13. The input panel 24 is an input device having a plurality of buttons that may be pushed to activate different functions, respectively. Among these buttons is a CD/DVD/HD DVD key that may be pushed to playback the optical disc loaded in the DVD-ROM drive 18, without the necessity of pushing the power button 14 to activate the computer 10.

The system configuration of the computer 10 will be described, with reference to FIG. 2.

As shown in FIG. 2, the computer 10 comprises a CPU 101, a north bridge 102, a main memory 103, a south bridge 104, a graphics processing unit (GPU) 105, a video memory (VRAM) 105A, a sound controller 106, a BIOS-ROM 109, a LAN controller 110, a hard disk drive (HDD) 111, an HD DVD drive 112, a card controller 113, a wireless LAN controller 114, an IEEE 1394 controller 115, and an embedded controller/keyboard controller (EC/KBC) IC 116.

The CPU 101 is a processor that is used to control some of the components of the computer 10. The CPU 101 executes the operating system and various application programs that have been loaded from the hard disk drive (HDD) 111 into the main memory 103. The application programs include an application program that the CPU 101 executes to play back the optical disc loaded in the drive 112.

The CPU 101 executes the basic input/output system (BIOS) stored in the BIOS-ROM 109, too. The BIOS is a program for controlling the hardware.

The HDD 111 has a storage area. Persistent storage is provided in a part of the storage area. The persistent storage needs to have a storage capacity of 64 MB or more. Nevertheless, the persistent storage is not limited to a part of the HDD 111. It may be a nonvolatile recording medium, such as a flash memory, fixed in the player (i.e., medium that cannot be removed from the player). Instead, it may be additional nonvolatile memory such as a USB memory, a portable HDD or a memory card. The persistent storage stores the additional content that accompanies the main content recorded on the optical disc. Examples of additional content are content which the content provider has provided via a network and which has been downloaded into the computer 10 and high scores for game content. The first-mentioned example of the additional content is, for example, video data added after the video software has been prepared, the original program prepared exclusively for the purchasers of the video software, audio data in languages other than the language in which the audio data contained in the video software, or the list of new arrivals, i.e., new video software items the provider has just started providing.

The north bridge 102 is a bridge device that connects the local bus of the CPU 101 to the south bridge 104. The north bridge 102 incorporates a memory controller that controls the access to the main memory 103. The north bridge 102 has the function of communicating with the GPU 105 via a serial bus conforming to the PCI Express standard.

The GPU 105 is a display controller that is used to control the LCD 17. The GPU 105 generates a video signal, which is supplied to the LCD 17. This video signal can be supplied to an external TV receiver 1 and an external high-definition multimedia interface (HDMI) monitor 2 via the interfaces 3 and 4 provided in the main unit 11, respectively.

The south bridge 104 controls the devices provided on a low-pin count (LPC) bus and the devices provided on a peripheral-component interconnect (PCI) bus. The south bridge 104 incorporates an integrated drive-electronics (IDE) controller that controls the HDD 111 and the HD DVD drive 112. The south bridge 104 has the function of communicating with the sound controller 106.

The sound controller 106 is a sound-source device. It outputs audio data to the speakers 19A and 19B. The speakers 19A and 19B generate sound from the audio data.

The card controller 113 controls a card such as a PC card or a secure digital (SD) card. The wireless LAN controller 114 is a wireless communication device that performs communication conforming to, for example, the IEEE 802.11 standard. Thus, the computer 10 is connected wirelessly to the Internet. The IEEE 1394 controller 115 can communicate with external apparatuses via serial buses conforming to the IEEE 1394 standard. The embedded controller/keyboard controller (EC/KBC) IC 116 is a one-chip microcomputer that comprises an embedded controller and a keyboard controller. The embedded controller is designed for power management. The keyboard controller is designed to control the keyboard (KB) 13, touchpad 15 and input panel 24. The embedded controller/keyboard controller (EC/KBC) IC 116 has the function of turning on or off the computer 10 when the user operates the power button 14. The embedded controller/keyboard controller (EC/KBC) IC 116 has another function of accomplishing communication with the remote-control unit interface 20.

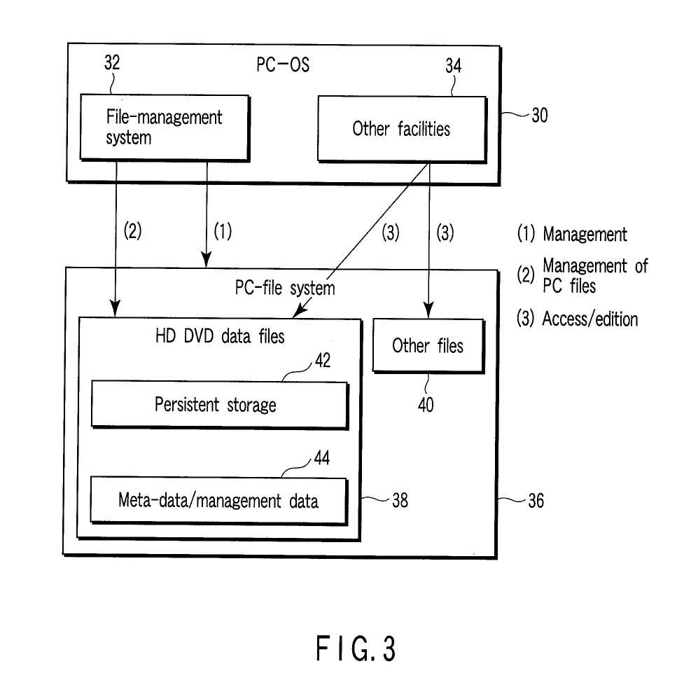

FIG. 3 is a diagram illustrating the relation between Operating System 30 of the personal computer 10 and a PC file system 36.

The HD DVD stores the metadata and management data about the content, in addition to the data in the persistent storage. HD DVD data files 38 such as data files 42 of the persistent storage and the metadata/management data 44 of the HD DVD are managed as ordinary PC files in the PC file system 36.

The PC file system 36 is controlled by the file management system 32 provided in the PC OS 30. Therefore, the file management system 32 manages the HD DVD data files 38 in the same way as it manages the ordinary PC files. Further, the HD DVD data files 38 can be accessed and edited (that is, read, written, generated and erased) in the same way as the ordinary PC files, by using other facilities 34 of the PC OS 30.

Thus, the PC OS 30 can control the HD DVD resources such as the data files 42 in the persistent storage, if the persistent storage stores application programs that can serve to play back HD DVDs. Since the PC OS 30 can manage the HD DVD resources, the HD DVD resources can be handled in the same manner as the PC files, by utilizing the user interface and the other facilities 34 of the PC OS 30. Hence, the data files in the persistent storage can be processed by using the user interface of the PC OS 30. The files can thereby be deleted or moved from the persistent storage if the free storage area of the persistent storage, available for new data, has become too small.

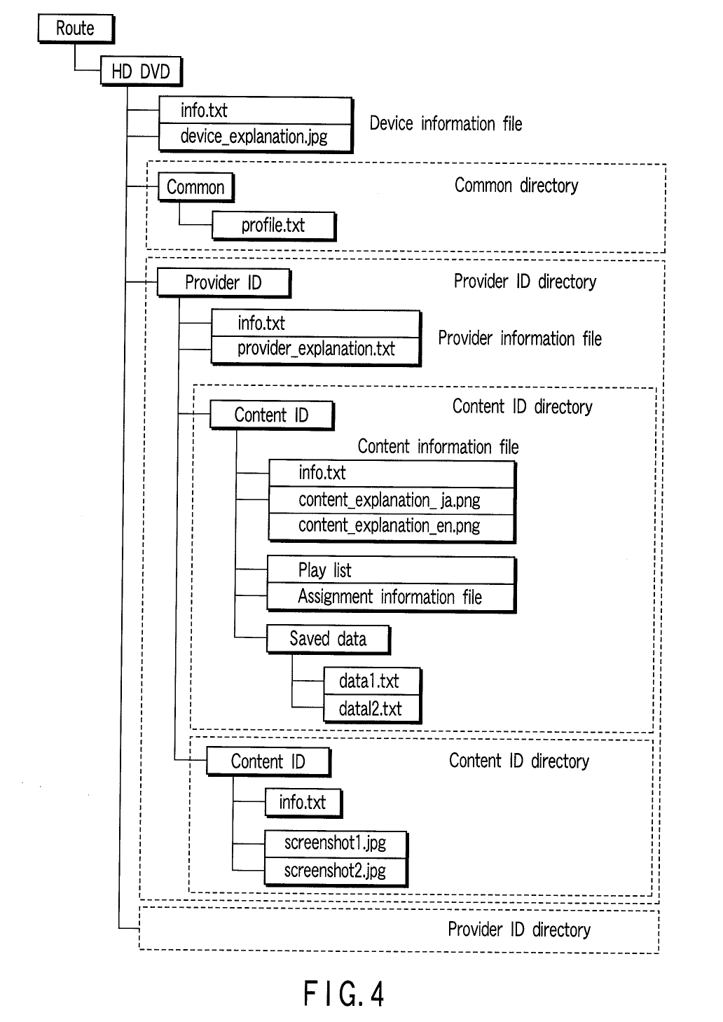

FIG. 4 shows an example of a physical directory configuration for the persistent storage. As FIG. 4 shows, the persistent storage stores a device information file, a provider information file, and content information files. That is, it stores three types of information files. All information files are recorded in the same format and have a file name, info.txt.

The device information file is arranged under the HD DVD directory that is, in turn, arranged under the root directory. The device information file describes the explanation of the persistent storage, i.e., device explanation.jpg. As indicated above, the persistent storage is not limited to a part of the HDD 111 and may be a medium, such as a flash memory, fixed in the player or an additional medium such as a memory card. This is why the file, device explanation.jpg, is arranged as device information file that designates the persistent storage.

One common directory and one or more provider ID directories are arranged under the HD DVD directory. Under the common directory, a file, profile.txt, is arranged.

The provider information file is arranged under a provider ID directory and describes the explanation of the provider, i.e., provider explanation.txt.

The content information files are arranged under the content ID directory of the provide ID directory. They describe the explanations of the content, i.e., content_explanation_ja.png, content_explanation_en.png, and screenshot1.jpg, and screenshot2.jpg.

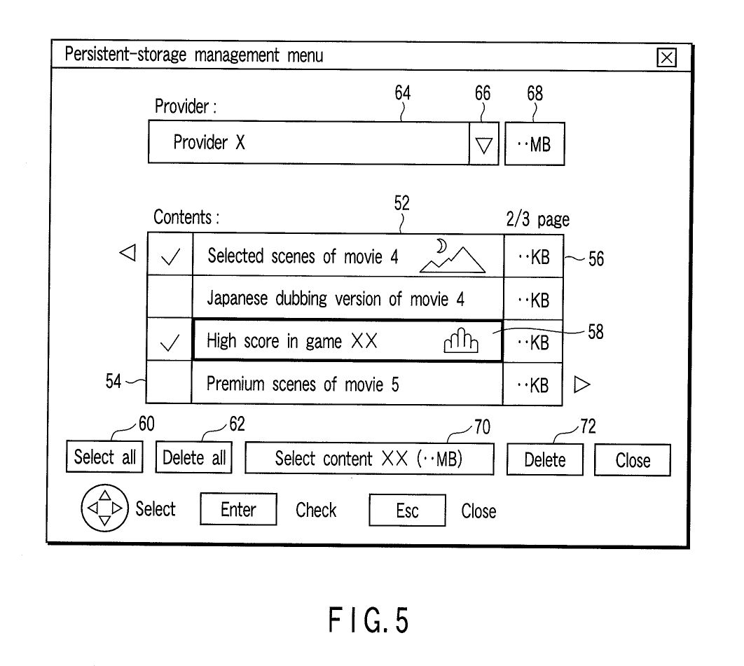

How the PC OS 30 operates to access and edit the data file 42 in the persistent storage will be explained. To access and edit this data file, such a persistent storage management menu as shown in FIG. 5 is used. This menu can be displayed any time, by clicking the “set” button displayed in the display window, thus calling a detailed setting dialog having tabs, and by clicking “menu display,” one of the items of “other settings.” Alternatively, the menu may be automatically displayed at the times preset in the play list. For example, it is displayed before additional content is downloaded via a network from the provider which has provided the content recorded on the optical disc (if the persistent storage has been set to any downloaded content automatically). Otherwise, the menu may be displayed when the free storage area of the persistent storage is detected to be smaller than a predetermined value (the PC OS 30 keeps monitoring the free storage area of the persistent storage). This is because the main objective of editing the data files in the persistent storage is to adjust the content (that is, to delete or move the content).

The persistent storage management menu displays content in groups, each group consisting of the content provided by the same provider. Contents 52 are displayed by displaying names of contents provided from each provider on content images (background images) in lateral boxes which extends horizontally. The content includes, for example, the high score in game XX. Checkboxes 54 are displayed on the left of the respective content images, and content sizes 56 are displayed on the right of the respective content images. When any checkbox is checked, selecting the content, a check is displayed in the checkbox. The check indicates that the content thus designated will be the next action object. The content 58 at which the cursor stays at present is encircled with a thick-line frame. The cursor is moved to select any other content, as the cross key and the enter key, both provided on the remote control unit, are operated in the order mentioned. To select all content, the user may select icon 60 displayed in the lower part of the menu. To cancel all the selected contents, the user may select icon 62 displayed in the lower part of the menu.

The name 64 of the provider is displayed, too, in a box that extends horizontally and displayed above the content boxes. On the right of the provider-name box, a pull-down box 66 is displayed. When the pull-down box 66 is checked, the provider is selected. All providers can be selected. The total size box 68 of all contents supplied from the provider is displayed on the right of the pull-down box 66.

An icon 70 is displayed at the center of the lower part of the menu. The icon 70 shows the number of all contents selected and the total size of all content selected.

Any content selected (indicated with a check in the checkbox) will be deleted if the user selects the “delete” icon 72 displayed in the lower part of the menu. When the content is thus deleted, the free storage area of the persistent storage increases.

The menu enables the user to confirm the content information stored in the persistent storage (i.e., the name of the provider and the names of the content items). Further, the user can select at least one content information item, the information about all contents provided by the provider, and the information about all contents provided by all providers (i.e., all content information stored in the persistent storage). Still further, the user can delete any content he or she has designated.

In conjunction with the menu it has been explained that the content information is deleted in the process of editing the content information. Nevertheless, if a plurality of persistent storage units is provided, the content may be copied or moved between the persistent storage units.

As has been described, the personal computer according to the first embodiment contains application programs that have the function of playing back HD DVDs. The operating system of the computer can control the HD DVD resources, such as the data files stored in the persistent storage, thus managing these HD DVD resources. The HD DVD resources can therefore be handled in the same way as ordinary files. Thus, the names of all content items in the persistent storage can be displayed in a list so that the content may be managed in an information-processing apparatus that executes application programs having the function of playing back HD DVDs to play back the content.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information-processing apparatus comprising:
means for reproducing information from an optical disc loaded in a disc unit using an application program;
a persistent storage configured to store content related to the optical disc;
a display device configured to display a list of information, the list of information comprising a name of the content stored in the persistent storage and a name of a provider of the content; and
means for processing the content that is stored in the persistent storage when at least a portion of the content is selected from the list of information.

2. The information-processing apparatus according to claim 1, wherein the processing means comprises means for deleting the selected portion of the content from the persistent storage.

3. The information-processing apparatus according to claim 1, wherein the persistent storage comprises at least one of a hard disk drive and a nonvolatile memory.

4. The information-processing apparatus according to claim 1, wherein the content comprises content provided via a network by a provider of a main content stored in the optical disc.

5. The information-processing apparatus according to claim 1, wherein the content comprises a high score of a game stored in the optical disc.

6. The information-processing apparatus according to claim 1, wherein the display device is configured to display lateral images of contents arranged in a vertical direction, names of the contents on the images, and sizes of the contents at sides of the images for every provider.

7. The information-processing apparatus according to claim 1, wherein the display device is configured to display the list when additional content is stored in the persistent storage.

8. The information-processing apparatus according to claim 1, wherein the display device is configured to display the list when a free storage area of the persistent storage becomes smaller than a predetermined value.

9. The information-processing apparatus according to claim 1, wherein the display device displays the list when list displaying is selected in a menu displayed to play back information from the optical disc.

10. An information-processing method for use in an information-processing apparatus which comprises means for reproducing information from an optical disc loaded in a disc unit by using an application program and a persistent storage configured to store content related to the optical disc, the method comprising:
displaying a list of information, the list of information comprising a name of the content stored in the persistent storage and a name of a provider of the content; and
processing any content that is stored in the persistent storage when at least a portion of the content is selected from the displayed list of information.

11. The information-processing method according to claim 10, wherein the processing comprises deleting the selected portion of the content from the persistent storage.

12. The information-processing method according to claim 10, wherein the content comprises content provided via a network by a provider of a main content stored in the optical disc.

13. The information-processing method according to claim 10, wherein the content comprises a high score of a game stored in the optical disc.

14. The information-processing method according to claim 10, wherein displaying a list of information comprises displaying lateral images of contents arranged in a vertical direction, names of the contents on the images, and sizes of the contents at sides of the images for every provider.

15. The information-processing method according to claim 10, wherein displaying the list of information comprises displaying the list when the content is stored in the persistent storage.

16. The information-processing method according to claim 10, wherein displaying the list of information comprises displaying the list when a free storage area of the persistent storage becomes smaller than a predetermined value.

17. The information-processing method according to claim 10, wherein the displaying comprises displaying the list when displaying the list when list displaying is in a menu displayed to play back information from the optical disc.
